(19) United States
(12) Patent Application Publication
(10) Pub. No.: US 2026/0028036 A1
(43) Pub. Date: Jan. 29, 2026

(54) DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/069,615

(22) Filed: Mar. 4, 2025

(30) Foreign Application Priority Data
Jul. 26, 2024 (JP) 2024-121432

(51) Int. Cl. B60W 50/14; B60R 1/27

(52) U.S. Cl. CPC B60W 50/14; B60R 1/27; B60R 2300/105; B60R 2300/607; B60W 2050/146

(57) ABSTRACT

A display control device includes a control unit that is configured to cause a display unit to display, based on detection information detectable by a vehicle, a surrounding image showing the surroundings of the vehicle as viewed from a virtual point of view and a vehicle image showing the vehicle as viewed from the virtual point of view, and that is configured to change the mode of the vehicle image according to the acquired detection information.

### CROSS-REFERENCE TO RELATED APPLICATION

This application claims priority to Japanese Patent Application No. 2024-121432 filed on Jul. 26, 2024. The disclosure of the above-identified application, including the specification, drawings, and claims, is incorporated by reference herein in its entirety.

### BACKGROUND

### 1. Technical Field

The present disclosure relates to display control devices.

### 2. Description of Related Art

Japanese Patent No. 7048398 (JP 7048398 B) discloses a vehicle control device capable of performing autonomous driving that gives an occupant a sense of security.

### SUMMARY

In the technique according to JP 7048398 B, an image showing a host vehicle, an image showing the surroundings of the host vehicle, etc. are displayed on a display unit (see FIG. 8 of JP 7048398 B). This technique does not present the viewpoint of changing the mode of the image showing the host vehicle according to detection information from a sensor etc. of the host vehicle, and there is still room for improvement in the method for displaying the image showing the host vehicle on the display unit.

It is an object of the present disclosure to provide a display control device that allows an occupant of a vehicle to easily grasp the situation of the vehicle based on a vehicle image.

A display control device of claim 1 includes
a control unit configured to cause, based on detection information detectable by a vehicle, a display unit to display a surrounding image and a vehicle image, and configured to change the mode of the vehicle image according to the detection information that has been acquired. The surrounding image is an image showing the surroundings of the vehicle as viewed from a virtual point of view, and the vehicle image is an image showing the vehicle as viewed from the virtual point of view.

In the display control device of claim 1, the control unit causes, based on the detection information, the display unit to display the surrounding image and the vehicle image as viewed from the virtual point of view. The control unit also changes the mode of the vehicle image according to the detection information that has been acquired. The display control device thus allows an occupant of the vehicle to easily grasp the situation of the vehicle based on the vehicle image.

According to a display control device of claim 2, in claim 1,
the control unit is configured to change the mode of a portion of the vehicle image when a decrease in detection accuracy of a detection unit is identified from the detection information. The portion of the vehicle image is a portion corresponding to the detection unit with the decreased detection accuracy.

In the display control device of claim 2, when a decrease in detection accuracy of the detection unit is identified from the detection information, the control unit changes the mode of the portion of the vehicle image that corresponds to the detection unit with the decreased detection accuracy. The display control device thus allows the occupant to identify which detection unit is malfunctioning or identify the cause of the malfunction, based on the vehicle image.

According to a display control device of claim 3, in claim 1 or 2,
the control unit is configured to reflect an open or closed state of an opening and closing unit of the vehicle in a portion of the vehicle image. The open or closed state is identified from the detection information, and the portion of the vehicle image is a portion corresponding to the opening and closing unit.

In the display control device of claim 3, the control unit reflects, in the portion of the vehicle image that corresponds to the opening and closing unit of the vehicle, the open or closed state of the opening and closing unit identified from the detection information. The display control device thus allows the occupant to know whether the opening and closing unit is in the open or closed state from the content displayed on the display unit.

According to a display control device of claim 4, in any one of claims 1 to 3,
the control unit is configured to damage a portion of the vehicle image when damage to a component of the vehicle is identified from the detection information. The portion of the vehicle image is a portion corresponding to the damaged component of the vehicle.

In the display control device of claim 4, when damage to a component of the vehicle is identified from the detection information, the control unit damages the portion of the vehicle image that corresponds to the damaged component of the vehicle. The display control device thus allows the occupant to know the location of the damage on the component or the condition of the damage from the content displayed on the display unit.

According to a display control device of claim 5, in any one of claims 1 to 4,
the control unit is configured to add damage information to the vehicle image when specific dangerous driving performed by an occupant of the vehicle is identified from the detection information. The damage information is information indicating that there is a possibility for the vehicle to be damaged.

In the display control device of claim 5, when the specific dangerous driving performed by the occupant of the vehicle is identified from the detection information, the control unit adds, to the vehicle image, the damage information indicating that there is a possibility for the vehicle to be damaged. The display control device thus allows the occupant to know, from the content displayed on the display unit, that the vehicle may be damaged by his or her own driving operation.

As described above, the display control device according to the present disclosure allows an occupant of the vehicle to easily grasp the situation of the vehicle based on a vehicle image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a flowchart illustrating a flow of an identification process;

FIG. 3 is a first display example displayed on a monitor;

FIG. 4 is a second display example displayed on a monitor;

FIG. 5 is a third exemplary display displayed on a monitor; and

FIG. 6 is a fourth display example displayed on the monitor.

### DETAILED DESCRIPTION OF EMBODIMENTS

Hereinafter, the vehicle 10 according to the present embodiment will be described.

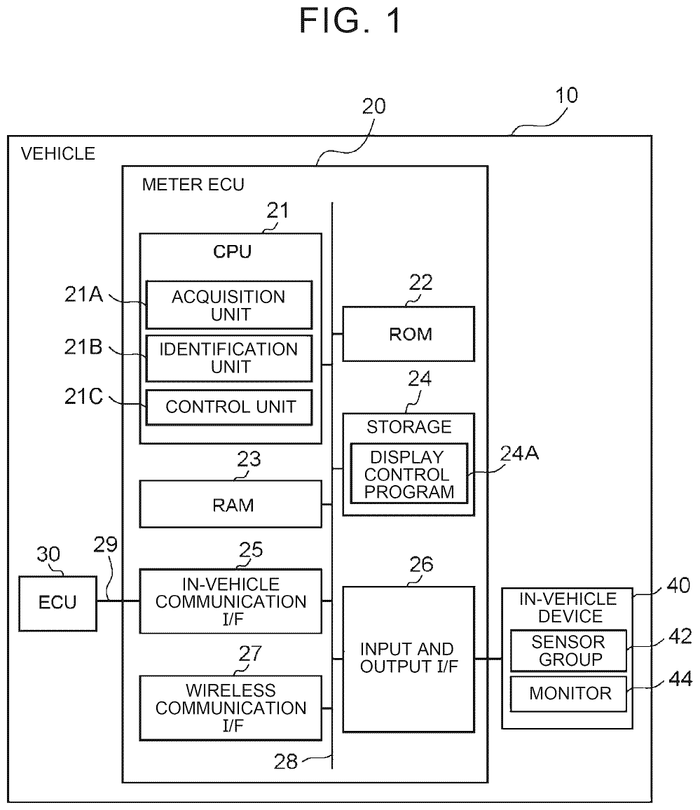

FIG. 1 is a block diagram illustrating a hardware configuration of a vehicle 10. As shown in FIG. 1, the vehicle 10 includes a meter ECU (Electronic Control Unit) 20. The vehicle 10 is an example of a “vehicle” of the present disclosure, and the meter ECU 20 is an example of a “display control device” of the present disclosure.

The meter ECU 20 includes CPU (Central Processing Unit) 21, ROM (Read Only Memory) 22, and RAM (Random Access Memory) 23. The meter ECU 20 further includes a storage 24, an in-vehicle communication I/F (Interface) 25, an input and output I/F 26, and a wireless communication I/F 27. CPU 21, ROM 22, RAM 23, the storage 24, the in-vehicle communication I/F 25, the input and output I/F 26, and the wireless communication I/F 27 are communicably connected to each other via an internal bus 28.

CPU 21 is a central processing unit that executes various programs and controls each unit. That is, CPU 21 reads the program from ROM 22 or the storage 24, and executes the program using RAM 23 as a working area. CPU 21 performs control of the above configurations and various arithmetic processes in accordance with programs recorded in ROM 22 or the storage 24.

ROM 22 stores various programs and various types of data. RAM 23 temporarily stores a program or data as a working area.

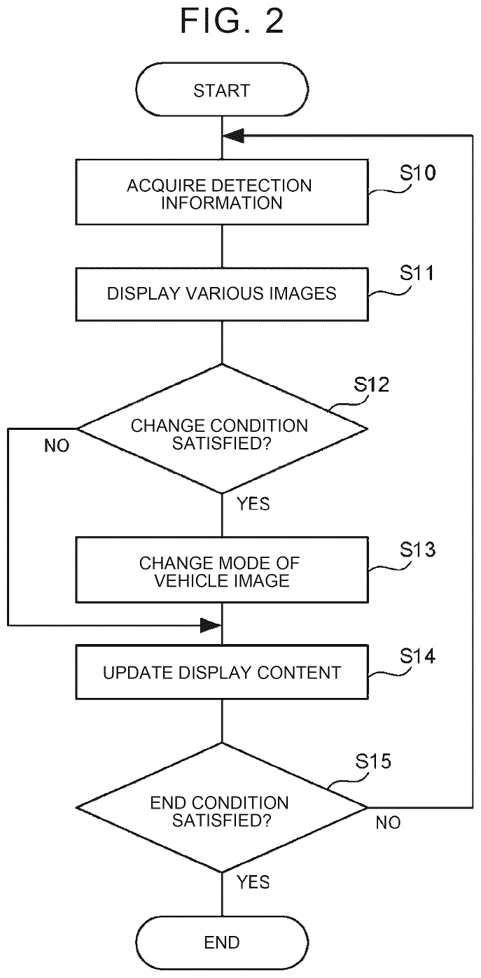

The storage 24 is constituted by a storage device such as a eMMC (embedded Multi-Media Card) or a UFS (Universal Flash Storage), and stores various programs and various types of data. The storage 24 stores a display control program 24A. The display control program 24A is a program for causing CPU 21 to perform an identification process (see FIG. 2) to be described later.

The in-vehicle communication I/F 25 is an interface for connecting to another ECU 30. The interface uses a communication standard according to a CAN protocol. The in-vehicle communication I/F 25 is connected to an external bus 29. Although not shown in the figures, a plurality of ECUs is provided for each function of the vehicle 10 in addition to the ECU 30.

The input and output I/F 26 is an interface for communicating with an in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes a sensor for detecting the state of the vehicle 10 and the surroundings of the vehicle 10, a plurality of cameras for imaging the surrounding of the vehicle 10, and the like. For example, the sensor group includes a 3D-LiDAR, a millimeter wave sensor, an infrared sensor, a winker sensor, an accelerator position sensor, a vehicle speed sensor, a steering angle sensor, and an angular velocity sensor. The sensor group further includes a GPS (Global Positioning System) sensor, an illuminance sensor, a gyroscope sensor, a steering angle sensor, an acceleration sensor, and the like. The sensor group 42 outputs a detection result of each sensor and an image captured by each camera to the meter ECU 20, the ECU 30, and the like.

The monitor 44 is a meter display provided on a meter panel disposed in front of the driver's seat of the vehicle 10 and for displaying an operation proposal related to the function of the vehicle 10, an image related to the explanation of the function, and the like. The monitor 44 is an example of a “display unit” of the present disclosure.

The wireless communication I/F 27 is a wireless communication module for communicating with an external device. As the wireless communication module, for example, communication standards such as 5G, LTE, Wi-Fi (registered trademark) and Bluetooth (registered trademark) are used.

Further, CPU 21 of the meter ECU 20 includes, as functional configurations, an acquisition unit 21A, an identification unit 21B, and a control unit 21C. The respective functional configurations are realized by CPU 21 reading and executing the display control program 24A stored in the storage 24.

The acquisition unit 21A acquires various types of information. For example, the acquisition unit 21A acquires detection information that can be detected by the vehicle 10 as various types of information. The detection information includes a detection result by each sensor constituting the sensor group 42, a captured image by each camera, and the like.

The identification unit 21B identifies the state of the vehicle 10 based on detection information acquired by the acquisition unit 21A. For example, the identification unit 21B identifies, as the state of the vehicle 10, the detection accuracy of the rear sensor for detecting the detection information on the rear side of the vehicle 10 in the sensor group 42 and the detection accuracy of the front camera for capturing an image of the front side of the vehicle 10 in the sensor group 42. The identification unit 21B identifies whether the left and right door mirrors are open or closed, whether the left and right door mirrors are damaged, and whether specific dangerous driving has occurred. The rear sensor and the front camera are examples of the “detection unit” of the present disclosure, and the door mirror is an example of the “opening and closing unit” and the “component” of the present disclosure.

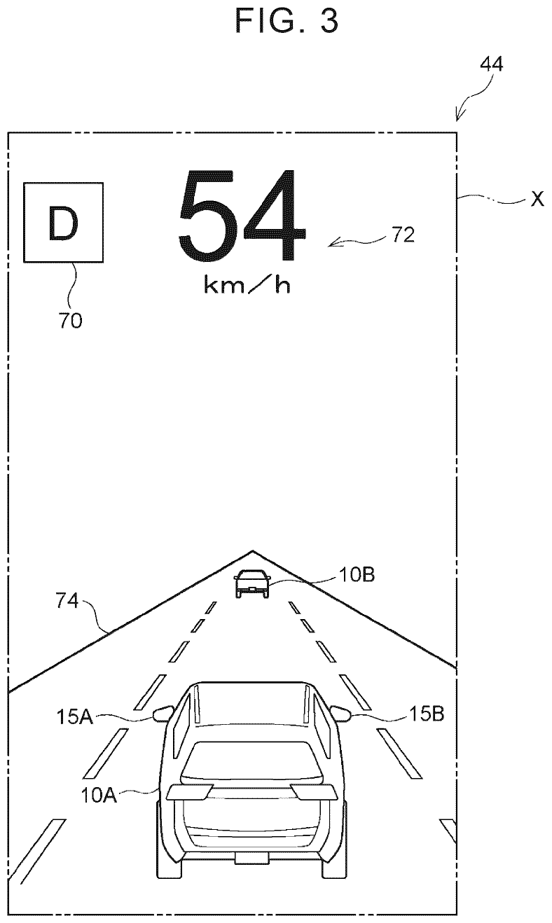

The control unit 21C performs display control related to the display of the monitor 44. For example, the control unit 21C causes the monitor 44 to display, as the display control, a vehicle image 10A (see FIG. 3 etc.) indicating the vehicle 10 when viewed from the virtual point of view, based on the detection information acquired by the acquisition unit 21A. The virtual point of view is set on a three-dimensional virtual space whose origin is the position of the vehicle image 10A, and is defined by the viewing coordinates and viewing angle (orientation) on the virtual space. For example, the virtual point of view is a point of view viewed at a specific viewing angle from specific viewing coordinates on the upper side of the vehicle image 10A in the virtual space. The control unit 21C is an example of the “control unit” of the present disclosure.

FIG. 2 is a flowchart illustrating a flow of an identification process that is performed by the meter ECU 20. CPU 21 reads the display control program 24A from the storage 24, loads it into the RAM 23, and executes it, thereby performing the identification process. As an example, the identification process is performed repeatedly and automatically every time a certain period of time elapses.

In S10 shown in FIG. 2, the CPU 21 acquires detection information detectable by the vehicle 10. Then, CPU 21 proceeds to S11.

In S11, CPU 21 displays various images on the monitor 44 based on the detection information acquired in S10. The various images are vehicle image 10A, other vehicle image 10B indicating another vehicle that is a preceding vehicle of the vehicle 10 (see FIG. 3 etc.), and a road image 74 (see FIG. 3 etc.) indicating a road on which the vehicle 10 and the other vehicle travel. Specific examples of the various images will be described later. Then, CPU 21 proceeds to S12. The other vehicle image 10B and the road image 74 are examples of the “surrounding image” of the present disclosure.

In S12, CPU 21 determines whether a change condition for changing the mode of the vehicle image 10A is satisfied. Here, CPU 21 proceeds to S13 when it is determined that the change condition is satisfied (S12: YES). On the other hand, if it is determined that the change condition is not satisfied (S12: NO), CPU 21 proceeds to S14. As an example, the change condition is satisfied when a decrease in detection accuracy of the rear sensor is identified, a decrease in detection accuracy of the front camera is identified, a damage to the door mirror is identified, or specific dangerous driving is identified.

In S13, CPU 21 changes the mode of the vehicle image 10A based on the change condition satisfied in S12. A specific example in which the mode of the vehicle image 10A is changed will be described later. Then, CPU 21 proceeds to S14.

In S14, CPU 21 updates the content displayed on the monitor 44 based on the detection information acquired in S10. For example, when the vehicle speed of the vehicle 10 increases or decreases, CPU 21 changes the numerical value shown in the vehicle speed information 72 (see FIG. 3 etc.) to be described later displayed on the monitor 44. Further, for example, when the vehicle 10 approaches another vehicle, CPU 21 narrows the inter-vehicle distance between the vehicle image 10A on the monitor 44 and the other vehicle image 10B. Then, CPU 21 proceeds to S15.

In S15, CPU 21 determines whether a predetermined end condition is satisfied. When the CPU 21 determines that the end condition is satisfied (S15: YES), the identification process ends. On the other hand, when it is determined that the end condition is not satisfied (S15: NO), CPU 21 returns to S10. As an example, CPU 21 determines that the end condition is satisfied when the ignition switch of the vehicle 10 is turned off.

Next, a display example of the monitor 44 will be described with reference to FIGS. 3 to 6.

FIG. 3 is a first illustration showing a display example displayed in the display area X of the monitor 44. The display area X is a partial area of the monitor 44, and is visible through an opening of the steering wheel by a driver seated in the driver's seat. As an example, FIG. 3 shows the content displayed when the change condition is not satisfied.

The shift information 70 and the vehicle speed information 72 are displayed in an upper portion of the display area X shown in FIG. 3.

The shift information 70 indicates a shift position of the vehicle 10. In FIG. 3, “D” is displayed as the shift information 70, indicating that the shift position is in the D range.

The vehicle speed information 72 indicates the vehicle speed of the vehicle 10. In FIG. 3, “54 km/h” is displayed as the vehicle speed information 72, indicating that the vehicle speed is 54 km/h.

In the display area X shown in FIG. 3, the road image 74 is displayed under the shift information 70 and the vehicle speed information 72. The road image 74 is an image showing a road around the vehicle 10 shown in the map data stored in the external server, the storage 24, etc.

In FIG. 3, the vehicle image 10A and the other vehicle image 10B are displayed on the road image 74.

The vehicle image 10A is an image generated based on the illustration design of the vehicle 10 shown in the illustration data stored in the storage 24. As an example, the vehicle 10 travels in the middle lane of a road with three lanes on each side. Therefore, in FIG. 3, the vehicle image 10A is displayed in the middle lane of the road shown in the road image 74 as viewed from the virtual point of view.

In the vehicle image 10A, the open or closed state of the door mirror identified from the detection information is reflected in the mirror portion 15 indicating the door mirror. For example, CPU 21 determines whether the door mirrors are open or closed based on images captured by side cameras mounted on the left and right door mirrors. Here, it is assumed that the left and right door mirrors are in an open state. Therefore, in the vehicle image 10A, both the left mirror portion 15A indicating the left door mirror and the right mirror portion 15B indicating the right door mirror are displayed open.

The other vehicle image 10B is an image generated based on the illustration design of the other vehicle indicated by the illustration data stored in the storage 24. As an example, the other vehicle is a preceding vehicle traveling in front of the vehicle 10 in the middle lane of a road with three lanes on each side. Therefore, in FIG. 3, the other vehicle image 10B is displayed in the middle lane of the road shown in the road image 74 at the upper side in the drawing of the vehicle image 10A as viewed from the virtual point of view.

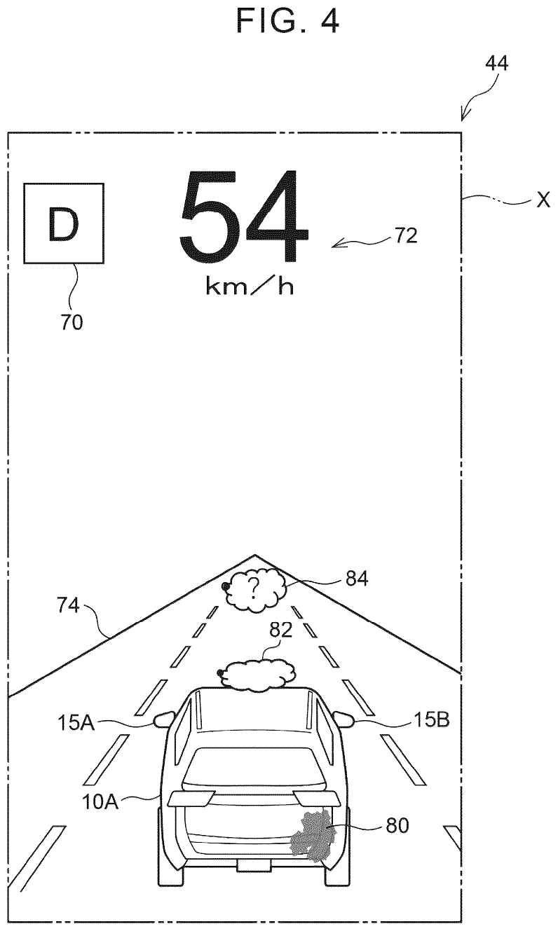

FIG. 4 is a second illustration showing a display example displayed in the display area X of the monitor 44. As an example, FIG. 4 shows a first specific example in which the mode of the vehicle image 10A changes.

In the display area X shown in FIG. 4, the vehicle image 10A, the shift information 70, the vehicle speed information 72, the road image 74, and the unknown target image 84 are displayed. Note that, among the pieces of information described above, a display mode other than the vehicle image 10A except for the unknown target image 84 is the same as that of FIG. 3, and therefore, description thereof will be omitted. The unknown target image 84 will be described later.

FIG. 4 illustrates a case where the change condition is satisfied based on the fact that CPU 21 has identified a decrease in detection accuracy of the rear sensor and the front camera. It is assumed that the rear sensors are provided one at each of the left side portion and the right side portion of the rear bumper. The front camera is attached to a license plate, a front grille, a front bumper, or the like. The CPU 21 identifies that the detection accuracy of the rear sensor or the front camera has decreased when it is detected by a known method that mud, water droplets, snow, ice, etc. is on the rear sensor or the front camera. It is assumed that a decrease in detection accuracy of a rear sensor (hereinafter, referred to as a “right rear sensor”) provided on the right side portion of the rear bumper and a front camera is identified.

In the above cases, the CPU 21 changes the mode of a portion of the vehicle image 10A that corresponds to the right rear sensor and the front camera that have decreased detection accuracy. For example, in the vehicle image 10A shown in FIG. 4, as a portion corresponding to the right rear sensor, a dirt mark 80 indicating dirt is added to a predetermined area indicating the right portion of the rear bumper in the vehicle image 10A. Further, in the vehicle image 10A shown in FIG. 4, a fog mark 82 indicating fogging of the lenses is added to a distal end portion of the vehicle body shown in the vehicle image 10A as a portion corresponding to the front camera.

The unknown target image 84 is an image displayed when CPU 21 cannot identify the type of the target (e.g., the type of a two-wheeled vehicle, a normal passenger vehicle, a freight vehicle, or the like) based on the detection information. As an example, the CPU 21 identifies the type of the target object in front of the vehicle 10 based on the captured image from the front camera included in the detection information. At this time, when the lens of the front camera is fogged, the detection accuracy of the front camera decreases, and as a result, the captured image by the front camera becomes blurry. When the captured images by the front cameras become blurry, the CPU 21 may not be able to identify the type of the target that exists in front of the vehicle 10. In such cases, CPU 21 displays such an unknown target image 84 as shown in FIG. 4 on the upper side of the vehicle image 10A in the figure, instead of the other vehicle image 10B shown in FIG. 3.

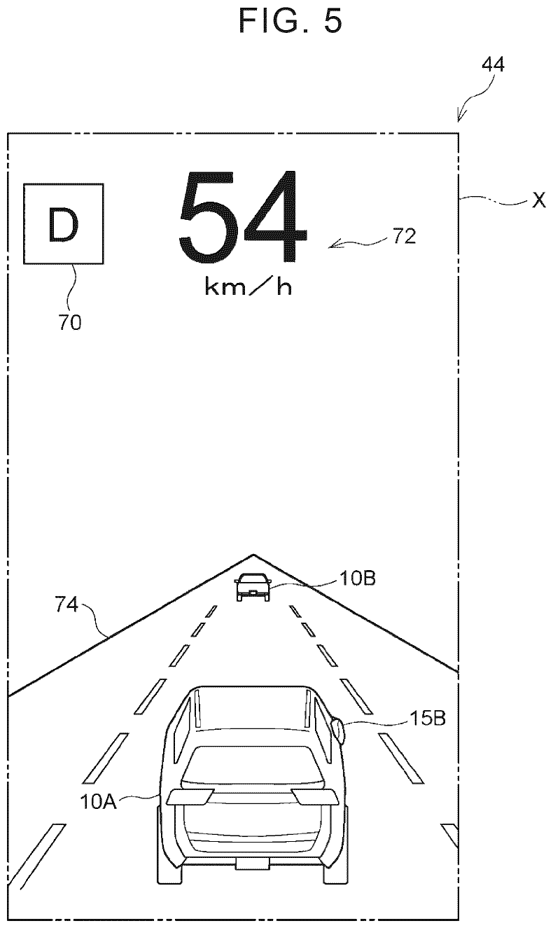

FIG. 5 is a third illustration showing a display example displayed in the display area X of the monitor 44. As an example, FIG. 5 shows a second specific example in which the mode of the vehicle image 10A changes.

In the display area X shown in FIG. 5, the vehicle image 10A, the other vehicle image 10B, the shift information 70, the vehicle speed information 72, and the road image 74 are displayed. Note that, among the pieces of information described above, a display mode other than the vehicle image 10A is the same as in FIG. 3, and therefore description thereof will be omitted.

FIG. 5 is a diagram illustrating a case where the change condition is satisfied based on the fact that the CPU 21 identifies a damage to the left door mirror from the detection information. As an example, when the captured image from the side camera mounted on the door mirrors cannot be acquired any more, the CPU 21 identifies that the door mirror whose captured image cannot be acquired any more is damaged. It is assumed that the left door mirror came off, and the lack of the left door mirror is identified as damage to the door mirror. In FIG. 5, it is assumed that the right door mirror is closed by an operation of a driver who is an occupant of the vehicle 10.

According to the above state, in the vehicle image 10A shown in FIG. 5, unlike the vehicle image 10A shown in FIG. 3, the left mirror portion 15A is erased and the right mirror portion 15B is closed.

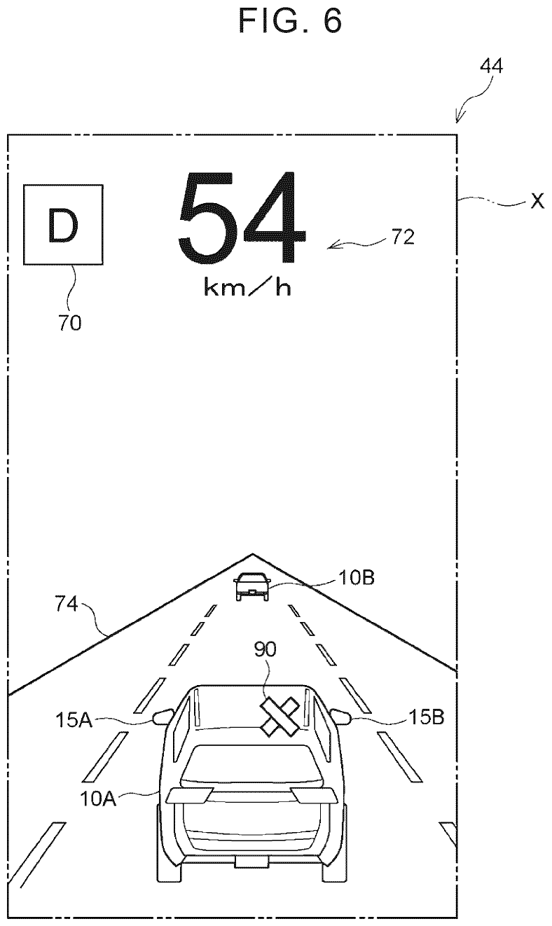

FIG. 6 is a fourth illustration showing a display example displayed in the display area X of the monitor 44. As an example, FIG. 6 shows a third specific example in which the mode of the vehicle image 10A changes.

In the display area X shown in FIG. 6, the vehicle image 10A, the other vehicle image 10B, the shift information 70, the vehicle speed information 72, and the road image 74 are displayed. Note that, among the pieces of information described above, a display mode other than the vehicle image 10A is the same as in FIG. 3, and therefore, explanation thereof is omitted.

FIG. 6 shows a case where the change condition is satisfied based on the fact that CPU 21 identifies that the specific dangerous driving has been performed. Specific dangerous driving is sudden acceleration, sudden braking, sudden steering, etc. As an example, CPU 21 identifies whether specific dangerous driving has been performed based on the detection results from the vehicle speed sensor, the acceleration sensor, and the steering angle sensor in the sensor group 42. It is assumed that sudden steering has been identified.

In this case, the CPU 21 adds, to the vehicle image 10A, damage information 90 indicating that there is a possibility for the vehicle 10 to be damaged by specific dangerous driving. For example, in the vehicle image 10A shown in FIG. 6, wound damage information 90 of a design imitating a bandage is added to a portion showing a roof in the vehicle image 10A.

As described above, in the meter ECU 20, CPU 21 displays, as a function of the control unit 21C, the other vehicle image 10B and the road image 74 as viewed from the virtual point of view and the vehicle image 10A on the monitor 44 based on the detection information. CPU 21 changes the mode of the vehicle image 10A according to the acquired detection information as a function of the control unit 21C. The meter ECU 20 allows the driver to easily grasp the situation of the vehicle 10 based on the vehicle image 10A.

In addition, a decrease in detection accuracy of the rear sensor and the front camera may be identified from the detection information. In the meter ECU 20, CPU 21 changes, as a function of the control unit 21C, a mode of a portion of the vehicle image 10A that corresponds to the rear sensor and the front camera that have decreased detection accuracy. The meter ECU 20 thus allows the driver to know which sensor or camera in the sensor group 42 is malfunctioning or the cause of the malfunction based on the vehicle image 10A.

In the meter ECU 20, as a function of the control unit 21C, the CPU 21 reflects the open or closed state of the door mirror of the vehicle 10 identified from the detection information on the portion of the vehicle image 10A that corresponds to the door mirror. The portion corresponding to the door mirror is the left mirror portion 15A and the right mirror portion 15B. The meter ECU 20 thus allows the driver to know whether the door mirror is open or closed from the content displayed on the monitor 44.

Damage to the door mirror of the vehicle 10 may be identified from the detection information. In the meter ECU 20, as a function of the control unit 21C, the CPU 21 damages the portion corresponding to the damaged door mirror (the left mirror portion 15A and the right mirror portion 15B) in the vehicle image 10A. The meter ECU 20 thus allows the driver to know the condition of the damage to the door mirror from the content displayed on the monitor 44.

In the meter ECU 20, as a function of the control unit 21C, the CPU 21 adds, to the vehicle image 10A, the damage information 90 indicating that there is a possibility for the vehicle 10 to be damaged, when the specific dangerous driving performed by the driver of the vehicle 10 is identified from the detection information. The meter ECU 20 thus allows the driver to know that the vehicle 10 may be damaged by his or her own driving operation from the content displayed on the monitor 44.

### Others

Although the embodiments of the present disclosure have been described in detail with reference to the accompanying drawings, the technical scope of the present disclosure is not limited to such examples. It will be apparent to those skilled in the art that various modifications and variations can be made within the scope of the technical idea described in the claims. It is to be understood that these variations or modifications are of course within the scope of the present disclosure.

Further, the effects described in the above embodiments are illustrative or exemplary, and are not limited to those described in the above embodiments. That is, the technology according to the present disclosure can produce other effects that are obvious to a person having ordinary knowledge in the technical field of the present disclosure from the description in the above embodiment, together with the effects described in the above embodiment or instead of the effects described in the above embodiment.

The process described in the above embodiment can also be implemented by a dedicated hardware circuit. In this case, it may be performed by one piece of hardware or may be performed by a plurality of pieces of hardware.

In the above embodiment, the display control program 24A is stored in the storage 24. However, the present disclosure is not limited thereto, and the display control program 24A may be stored in ROM 22.

In the above embodiment, the rear sensor and the front camera are examples of the “detection unit” of the present disclosure, but the example of the “detection unit” is not limited thereto. Each of the sensors for detecting the state of the vehicle 10 and the surroundings of the vehicle 10 in the sensor group 42, and the cameras for imaging the surrounding of the vehicle 10 can be an example of a “detection unit”.

In the above embodiment, the door mirror is an example of the “opening and closing unit” of the present disclosure, but the example of the “opening and closing unit” is not limited to this as long as its open and closed states can be identified from the detection information. For example, the door, the rear gate, etc. of the vehicle 10 may be an example of an “opening and closing unit”.

In the above embodiment, the door mirror is an example of the “component” of the present disclosure, but the example of the “component” is not limited to this as long as damage can be identified from the detection information. For example, a tire or the like of the vehicle 10 may be an example of the “component”. In the above embodiment, the lack of the component is identified as “damage to the component”, but the damage is not limited to this. The damage includes, in addition to the lack of the component, scratching of the component. When a scratched component is identified as “damage to the component” from the detection information, an image (mark) indicating the damage may be added to a portion of the vehicle image 10A that corresponds to the damaged component. In this case, a plurality of marks indicating damage may be prepared, and CPU 21 may add a mark corresponding to the type of damage identified from the detection information to the vehicle image 10A.

In the above embodiment, the form of the dirt mark 80 is not limited to that shown in FIG. 4. For example, the dirt marks 80 in the forms corresponding to a plurality of states of the dirt may be prepared in advance, and CPU 21 may add the dirt mark 80 in the form corresponding to the state of the dirt estimated from the detection information to the vehicle image 10A. For example, if the weather around the vehicle 10 is rain, CPU 21 may add a dirt mark 80 designed to represent a water droplet to the vehicle image 10A. In addition, CPU 21 may add a dirt mark 80 designed to represent a snow crystal to the vehicle image 10A when the weather around the vehicle 10 is snow. Further, CPU 21 may add a dirt mark 80 designed to represent ice to the vehicle image 10A when the outside air temperature around the vehicle 10 is equal to or lower than a predetermined value. As described above, since the dirt mark 80 in the form corresponding to the state of the dirt estimated from the detection information is added to the vehicle image 10A, it is possible to cause the driver to know the state of the dirt on the detection unit with the decreased detection accuracy, and to take a measure according to the state of the dirt.

In the above embodiment, the form of the damage information 90 is not limited to that shown in FIG. 6. For example, the damage information 90 in the forms corresponding to a plurality of types of specific dangerous driving may be prepared in advance, and the CPU 21 may add, to the vehicle image 10A, the damage information 90 in the form corresponding to the specific dangerous driving identified from the detection information.

In the above embodiment, sudden acceleration, sudden braking, and sudden steering are examples of the “specific dangerous driving” of the present disclosure, but the example of the “specific dangerous driving” is not limited to these as long as it can be identified from the detection information. For example, CPU 21 may identify that specific dangerous driving has been performed when a specific driving assistance function such as Emergency Driving Stop System (EDSS) and Lane Departure Alert (LDA) is performed.

In the above embodiment, the monitor 44, which is a meter display, is an example of the “display unit” of the present disclosure, but the example of the “display unit” is not limited to the meter display. For example, an exemplary “display” may be other displays, such as a center display and a head-up display (HUD). An example of the “display unit” may be a combination of a plurality of displays such as a meter display and a center display.

In the above embodiment, the meter ECU 20 performs the identification process shown in FIG. 2. However, the present disclosure is not limited thereto, and the identification process may be performed by the meter ECU 20 and other ECU in cooperation with each other.

The identification process that is performed by the CPU 21 reading the software (program) in the above embodiment may be performed by various processors other than CPU. Examples of the processor include a PLD (Programmable Logic Device) in which the circuit configuration can be changed after manufacturing, and a dedicated electric circuit that is a processor having a circuit configuration designed specifically for performing a specific process. PLD that can change the circuitry after manufacturing is FPGA (Field-Programmable Gate Array). Dedicated electric circuits, which are processors with circuit configurations designed exclusively for performing specific processes, are ASIC (Application Specific Integrated Circuit) and the like. The identification process may be performed by one of these various processors, or may be performed by a combination of two or more processors (for example, a plurality of FPGA, a combination of CPU and FPGA, and the like) of the same type or different types. Further, the hardware configuration of the various processors is, more specifically, an electric circuit in which circuit elements such as semiconductor elements are combined.

The above embodiment illustrates the form in which the display control program 24A is stored (installed) in advance in the storage 24, but the present disclosure is not limited thereto. The display control program 24A may be provided in a form recorded on a recording medium. Examples of the recording medium include CD-ROM (Compact Disk Read Only Memory) and DVD-ROM (Digital Versatile Disk-Read Only Memory). Further, the recording medium may be a USB (Universal Serial Bus) memory or the like. In addition, the display control program 24A may be downloaded from an external device via a network. Note that the technology of the present disclosure can also be applied to programs and program products.

What is claimed is:

1. A display control device comprising a control unit configured to cause, based on detection information detectable by a vehicle, a display unit to display a surrounding image and a vehicle image, and configured to change a mode of the vehicle image according to the detection information that has been acquired, the surrounding image being an image showing surroundings of the vehicle as viewed from a virtual point of view, and the vehicle image being an image showing the vehicle as viewed from the virtual point of view.

2. The display control device according to claim 1, wherein the control unit is configured to change a mode of a portion of the vehicle image when a decrease in detection accuracy of a detection unit is identified from the detection information, the portion of the vehicle image being a portion corresponding to the detection unit with the decreased detection accuracy.

3. The display control device according to claim 1, wherein the control unit is configured to reflect an open or closed state of an opening and closing unit of the vehicle in a portion of the vehicle image, the open or closed state being identified from the detection information, and the portion of the vehicle image being a portion corresponding to the opening and closing unit.

4. The display control device according to claim 1, wherein the control unit is configured to damage a portion of the vehicle image when damage to a component of the vehicle is identified from the detection information, the portion of the vehicle image being a portion corresponding to the damaged component of the vehicle.

5. The display control device according to claim 1, wherein the control unit is configured to add damage information to the vehicle image when specific dangerous driving performed by an occupant of the vehicle is identified from the detection information, the damage information being information indicating that there is a possibility for the vehicle to be damaged.
